(19) United States
(12) Patent Application Publication
(10) Pub. No.: US 2025/0246640 A1
(43) Pub. Date: Jul. 31, 2025

(54) ELECTRODE COMPRISING CERIA NANOTUBE ANTIOXIDANT, AND MEMBRANE-ELECTRODE ASSEMBLY AND FUEL CELL COMPRISING THE SAME

(71) Applicant: KOREA INSTITUTE OF SCIENCE AND TECHNOLOGY, Seoul (KR)

(72) Inventors: Jin Young KIM, Seoul (KR); Ho Young KIM, Seoul (KR); Yeong-Seop LEE, Seoul (KR); Jong Hyun JANG, Seoul (KR)

(73) Assignee: KOREA INSTITUTE OF SCIENCE AND TECHNOLOGY, Seoul (KR)

(21) Appl. No.: 18/980,180

(22) Filed: Dec. 13, 2024

(30) Foreign Application Priority Data
Dec. 15, 2023 (KR) 10-2023-0183329

(51) Int. Cl. H01M 4/86; H01M 4/92; H01M 8/1004

(52) U.S. Cl. CPC H01M 4/8663; H01M 4/92; H01M 8/1004

(57) ABSTRACT

Provided are an electrode including a ceria nanotube antioxidant, and a membrane-electrode assembly (MEA) and a fuel cell including the electrode. More specifically, provided is a fuel cell electrode including a catalyst layer including a ceria nanotube antioxidant, and a catalyst.

### CROSS-REFERENCE TO RELATED APPLICATIONS

This application claims the benefit of Korean Patent Application No. 10-2023-0183329 filed on Dec. 15, 2023, in the Korean intellectual property office, the entire disclosure of which is incorporated herein by reference for all purposes.

### TECHNICAL FIELD

One or more embodiments relate to an electrode including a ceria nanotube antioxidant, and a membrane-electrode assembly and a fuel cell including the same.

### DESCRIPTION OF RELATED ART

Polymer electrolyte membrane fuel cells (PEMFCs) are energy-efficient and environmentally friendly energy devices that are attracting attention as a next-generation power source. The PEMFC, a low-temperature fuel cell, has high usability as a mobile fuel cell for automobiles and drones.

Among the components of the PEMFC, a membrane-electrode assembly (MEA) is a key material that determines the performance of the fuel cell and is composed of a catalyst layer where an electrode reaction occurs and an electrolyte membrane. Since the MEA accounts for approximately 40% of a total cost of each fuel cell component, the development of long-life MEA is expected to be a solution to the major issues of the PEMFC technology.

The main cause of the performance degradation shown in an MEA material is chemical damage to the material due to hydrogen peroxide and radical chemical species formed inside the MEA by electrode side reactions and hydrogen/oxygen gas permeation in a PEMFC operating environment, which is inevitably generated during PEMFC driving.

To prevent such chemical damage, an antioxidant capable of removing radicals through reversible oxidation/reduction reactions may be utilized and may be included in an electrode layer and/or an electrolyte membrane. The most commonly used material is cerium oxide, but cerium oxide is thermodynamically unstable under acidic conditions, which may lead to a decrease in PEMFC performance due to aggregation of nanoparticles by dissolution and a decrease in proton conductivity of the electrolyte membrane.

Therefore, it is necessary to develop antioxidant materials to improve an effective radical removal function, durability, and performance of MEA materials.

### DESCRIPTION OF INVENTION

### Technical Goals

Embodiments may provide a catalyst layer, to which a ceria nanotube antioxidant is applied, and a fuel cell electrode with an effective radical removal function and improved durability and performance using the same, and a membrane-electrode assembly (MEA) and a fuel cell including the same.

However, technical goals to be achieved are not limited to those described above, and other goals not mentioned above can be clearly understood by one of ordinary skill in the art from the following description.

### Technical Solutions

According to an aspect, there is provided an electrode for fuel cell including a catalyst layer including a ceria nanotube antioxidant, and a catalyst.

The ceria nanotube antioxidant may have a Brunauer-Emmett-Teller (BET) specific surface area of 100 m²g⁻¹ or more, a diameter of 1 nanometer (nm) to 20 nm, and a length of 30 nm or more.

A proportion of Ce³⁺ in the ceria nanotube antioxidants may be 30% or more.

A mass ratio (w/w) of the ceria nanotube antioxidant to the catalyst may be 1:1 to 30.

The catalyst may be a platinum catalyst.

A loading amount of the ceria nanotube antioxidant in the catalyst layer may be 0.1 μg cm⁻² to 1 μg cm⁻².

A change rate of an electrochemical active surface area (ECSA) of the catalyst layer according to Equation 1 may be 30% or less, and a change rate of mass activity (MA) of the catalyst layer of the catalyst according to Equation 2 may be 20% or less.

$$Change rate ( \% ) = ( [ Initial ECSA value - ECSA value after 5 , 000 cycles ] / [ Initial ECSA value ] ) * 100 \qquad [ Equation 1 ]$$

$$Change rate ( \% ) = ( [ Initial MA value - MA value after 5 , 000 cycles ] / [ Initial MA value ] ) * 100 \qquad [ Equation 2 ]$$

The electrode may include an ionomer included in an amount of 1 wt % to 30 wt % with respect to a total weight of the ceria nanotube antioxidant in the catalyst layer.

According to another aspect, there is provided an MEA including a first electrode layer including the electrode according to the present disclosure, a second electrode layer, and an electrolyte membrane between the first electrode layer and the second electrode layer.

According to still another aspect, there is provided a fuel cell including the MEA according to the present disclosure.

A change rate of an open circuit voltage (OCV) with respect to a unit cell according to Equation 3 may be 15% or less.

Change rate (%)=([Initially applied OCV−OCV after 100 hours]/[Initial OCV])*100 (“OCV after 100 hours” corresponds to a voltage after the OCV is applied continuously at 2-hour intervals for 100 hours) [Equation 3]

### Effects of Invention

According to embodiments, it is possible to provide a ceria nanotube antioxidant, which is a highly efficient antioxidant, and provide an electrode (i.e., a catalyst layer) in which the ceria nanotube antioxidant is introduced. Also, it is possible to provide an fuel cell electrode with an effective radical removal function and improved durability and performance using the same, and an MEA and a fuel cell including the same.

### BRIEF DESCRIPTION OF THE DRAWINGS

FIG. 1A illustrates transmission electron microscope (TEM) images (high and low magnifications) of ceria nanotube (CeOₓ NT) manufactured in Example 1 according to an embodiment.

FIG. 1B illustrates TEM images (high and low magnifications) of commercial ceria nanoparticles (CeOₓ NP) used in Comparative Example 1 according to an embodiment.

FIG. 1C illustrates TEM images (high and low magnifications) of ceria nanorods (CeOₓ NR), an intermediate product of Example 1, according to an embodiment.

FIG. 2 illustrates X-ray diffraction (XRD) pattern analyses of ceria of Example 1, Comparative Example 1, and Comparative Example 2 according to an embodiment.

FIGS. 3A and 3B show results of analysis of physicochemical structures of ceria of Example 1, Comparative Example 1, and Comparative Example 2 according to an embodiment, wherein FIG. 3A shows a result of N₂ physical adsorption and desorption analysis and FIG. 3B shows an analysis of an X-ray photoelectron spectrum.

FIGS. 4A, 4B, 4C, and 4D show results of analysis of ORR characteristic of catalyst layers manufactured in Example 1, Comparative Example 1, and Comparative Example 2 according to an embodiment, wherein FIG. 4A shows a cyclic voltammetry (CV) graph, FIG. 4B shows an ORR graph, FIG. 4C shows an analysis of changes in an electrochemical active surface area (ECSA) before and after durability evaluation, and FIG. 4D shows an analysis of changes in mass activity (MA) before and after durability evaluation.

FIGS. 5A, 5B, and 5C show analyses of oxygen affinity of catalyst layers manufactured in Example 1, Comparative Example 1, and Comparative Example 2 according to an embodiment.

FIG. 6 shows evaluation of hydrogen peroxide reduction rates of catalyst layers according to an embodiment, which is evaluation of hydrogen peroxide reduction rates of catalyst layers manufactured in Example 1, Comparative Example 1, and Comparative Example 2.

FIGS. 7A and 7B show comparisons of current-voltage performance (FIG. 7A) and current-power performance (FIG. 7B) of a polymer electrolyte membrane fuel cell (PEMFC) unit cell manufactured using a catalyst layer of Example 1 according to an embodiment.

FIGS. 8A, 8B, and 8C show comparisons of durability of a PEMFC unit cell manufactured using a catalyst layer of Example 1 according to an embodiment.

### DETAILED DESCRIPTION

Hereinafter, embodiments of the present disclosure will be described in detail with reference to the accompanying drawings. When it is determined detailed description related to a related known function or configuration they may make the purpose of the present disclosure unnecessarily ambiguous in describing the present disclosure, the detailed description will be omitted here. In addition, terminologies used herein are defined to appropriately describe the embodiments and thus may be changed depending on a user, the intent of an operator, or a custom of a field to which the present disclosure pertains. Accordingly, the terminologies must be defined based on the following overall description of the present specification. In the drawings, like reference numerals are used for like elements.

In the whole specification, when a member is positioned “on” another member, this not only includes a case that the any member is brought into contact with the other member, but also includes a case that another member exists between two members.

It will be understood that when a certain part “includes” a certain component, the part does not exclude another component but may further include another component.

As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms such as “1^{st}”, “2^{nd}”, or “first” or “second” may simply be used to distinguish the component from other components in question, and do not limit the components in other aspects (e.g., importance or order). For example, suitable results may be achieved if the described techniques are performed in a different order and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

Hereinafter, an electrode, a membrane-electrode assembly (MEA) including the electrode, and a fuel cell of the present disclosure will be described in detail with reference to embodiments and drawings. However, the present disclosure is not limited to the embodiments and drawings.

According to an embodiment, an electrode of the present disclosure may include a catalyst layer including a ceria nanotube antioxidant (hereinafter, referred to as a ceria nanotube), a catalyst, and an ionomer, and may be an electrode for a fuel cell.

According to an embodiment, the ceria nanotube antioxidant may have a three-dimensional structure with a large specific surface area, and strain and plentiful defective structures on a surface thereof, and provide excellent reactivity due to a nanospace confinement effect induced in an internal cavity. Due to such excellent reactivity, atomic interaction with the catalyst (e.g., platinum) is stronger than that of ceria antioxidants having other structures (e.g., nanoparticles, rods, and the like), so that oxidation prevention efficiency on a surface of the catalyst (e.g., platinum) is high and radical chemical species may be effectively removed.

According to an embodiment, the ceria nanotube antioxidant may be mass-synthesized through a simple hydrothermal synthesis process, may be used to manufacture an MEA based on a coating process of the related art, and thus may be advantageous for large-area production. In addition, since the antioxidant is included in an electrode layer, excellent cell performance may be secured without interference with proton conduction and initial performance degradation.

According to an embodiment, “ceria” here is represented by CeOₓ, where x may be a rational number of 1 to 2 (excluding negative values).

According to an embodiment, the ceria nanotube may have a specific surface area of 100 m²g⁻¹ or more; 110 m 2 m²g⁻¹ or more; 140 m²g⁻¹ or more; or 100 m²g⁻¹ to 200 m²g⁻¹. The specific surface area may be a Brunauer-Emmett-Teller (BET) specific surface area measured by nitrogen adsorption amount by BET. Such a specific surface area may secure excellent reactivity and improve anti-oxidation efficiency and a removal rate of radical chemical species. The BET specific surface area may be obtained by using a method and/or device known in the technical field of the present disclosure, and is not specifically mentioned herein. For example, based on the registration of an adsorption isotherm of liquid nitrogen in a range of p/p0=0.04-0.26 at about 77 K, monolayer capacity may be determined according to a method proposed by Brunauer, Emmet, and Teller (adsorption of gas in multimolecular layer, J. Am. Chem. Soc, 1938, 60, 309-319). A specific surface may be obtained based on a cross-sectional area of a nitrogen molecule.

According to an embodiment, the ceria nanotube may have a diameter (or thickness) of 1 nm to 20 nm; 2 nm to 18 nm; 5 nm to 15 nm; or 5 nm to 10 nm. According to an embodiment, the ceria nanotube may have a length of 30 nm or more; 60 nm or more; 100 nm or more; 200 nm or more; 300 nm or more; 500 nm or more; or 1,000 nm or more. Desirably, the length of the ceria nanotube may be 100 nm to 800 nm. By applying the diameter and length ranges, excellent reactivity may be secured, and the anti-oxidation efficiency and the removal rate of the radical chemical species may be improved.

According to an embodiment, a proportion of Ce³⁺ in the ceria nanotube may be 30% or more; 35% or more; or 40% or more (or 40% or less). The proportion of Ce³⁺ may be obtained based on peak intensity in X-ray photoelectron spectrum analysis. That is, the durability of a battery may be improved by securing the proportion of Ce³⁺ with high radical scavenging reactivity.

According to an embodiment, the catalyst of the catalyst layer may be applied without limitation as long as it is a catalyst applicable to a fuel cell, and the catalyst may include one or more types selected from the group consisting of a metal, metal oxide, and a metal alloy. For example, the metal may include one or more types selected from the group consisting of platinum (Pt), copper (Cu), nickel (Ni), manganese (Mn), cobalt (Co), tungsten (W), iron (Fe), iridium (Ir), ruthenium (Ru), rhodium (Rh), silver (Ag), gold (Au), osmium (Os), chromium (Cr), molybdenum (Mo), vanadium (V), palladium (Pd), titanium (Ti), zirconium (Zr), zinc (Zn), boron (B), aluminum (Al), gallium (Ga), tin (Sn), lead (Pb), antimony (Sb), selenium (Se), tellurium (Te), cesium (Cs), rubidium (Rb), magnesium (Mg), strontium (Sr), cerium (Ce), praseodymium (Pr), neodymium (Nd), samarium (Sm), and rhenium (Re). Desirably, it may be a platinum catalyst. For example, the catalyst may be supported in an amount of 30 wt % to 80 wt % on a support (e.g., carbon material: graphite, graphene, carbon black, etc. in a form of a nano-sheet, nanofiber, nanotube, spherical particle, etc.). For example, the catalyst may be a platinum catalyst supported on carbon (e.g., 40 wt % to 50 wt % Pt/C).

According to an embodiment, a mass ratio of the ceria nanotube antioxidant to the catalyst (e.g., platinum catalyst) in the catalyst layer may be 1:1 to 30; 1:5 to 30; 1:10 to 30; 1:15 to 25; or desirably 1:20 to 25. By applying this mass ratio, an electrode and a fuel cell with improved durability and performance may be provided.

According to an embodiment, a loading amount of the catalyst (e.g., platinum catalyst) in the catalyst layer may be 1 μg cm⁻² to 20 μg cm⁻²; 5 μg cm⁻² to 15 μg cm⁻²; 8 μg cm⁻² to 15 μg cm⁻²; or 8 μg cm⁻² to 12 μg cm⁻². According to an embodiment, a loading amount of the ceria nanotube antioxidant in the catalyst layer may be 0.1 μg cm⁻² to 1 μg cm⁻²; 0.3 μg cm⁻² to 1 μg cm⁻²; 0.4 μg cm⁻² to 0.9 μg cm⁻²; or 0.4 μg cm⁻² to 0.6 μg cm⁻². By applying the loading amount described above, an electrode and a fuel cell with improved durability and performance may be provided.

According to an embodiment, the ionomer in the catalyst layer may include a liquid ionomer, a solid ionomer, or both. The ionomer may be included in an amount of 1 wt % to 30 wt %; 1 wt % to 20 wt %; 1 wt % to 10 wt %; or 1 wt % to 5 wt % with respect to a total weight of the ceria nanotube antioxidant. By applying the amount described above, the antioxidant may be effectively fixed to the catalyst layer. The ionomer may be applied without limitation as long as it is an ionomer applicable to a fuel cell in the technical field of the present disclosure, and may include, for example, one or more types selected from the group consisting of a perfluorinated polymer, a sulfonated hydrocarbon-based polymer, a benzimidazole-based polymer, a polyimide (PI)-based polymer, a polyetherimide-based polymer, a polyether ketone-based polymer, a polyether-ether ketone-based polymer, and a polyphenylquinoxaline-based polymer, but is not limited thereto. Examples of the perfluorinated polymer may include, but are not limited to, one or more types selected from the group consisting of Nafion (DuPont), Flemion (Asahi Glass), Asiplex (Asahi Chemical), Dow XUS (Dow Chemical), and Aquivion (Solvay). Examples of the sulfonated hydrocarbon-based polymer may include, but are not limited to, one or more types selected from the group consisting of sulfonated polyarylene ether sulfone (S-PES), sulfonated polybenzimidazole (S-PBI), sulfonated polyether ketone (S-PEEK), poly(para)phenylene (S-PP), sulfonated PI (S-PI), sulfonated polysulfone (S-PS), and sulfonated polyphenyl sulfone.

According to an embodiment, a change rate of an electrochemical active surface area (ECSA) of the catalyst layer (or electrode) according to Equation 1 below may be 30% or less; 28% or less; 25% or less; or 20% or less.

$$Change rate ( \% ) = ( [ Initial ECSA value - ECSA value after 5 , 000 cycles ] / [ Initial ECSA value ] ) * 100 \qquad [ Equation 1 ]$$

According to an embodiment, a change rate of mass activity (MA) of the catalyst layer of the catalyst according to Equation 2 below may be 20% or less; 15% or less; or 10% or less.

$$Change rate ( \% ) = ( [ Initial MA value - MA value after 5 , 000 cycles ] / [ Initial MA value ] ) * 100 \qquad [ Equation 2 ]$$

According to an embodiment, According to an embodiment, an MEA may include a first electrode including the electrode according to the present disclosure; an electrolyte membrane; and a second electrode which is a counter electrode. In addition, the MEA may further include components necessary for driving or operating, such as a gas diffusion layer or the like, but these are not specifically described herein.

According to an embodiment, the first electrode may be a cathode electrode, which is an electrode including the ceria nanotube antioxidant according to the present disclosure. The second electrode may be an anode electrode. The first electrode and the second electrode may each be formed on one surface of the electrolyte membrane.

According to an embodiment, the electrolyte membrane is an ion exchange membrane including a hydrogen ion conductive polymer applicable to a fuel cell, and the type thereof may be a single membrane, a composite membrane, or a reinforced composite membrane. For example, the reinforced composite membrane may be a reinforced composite membrane including a porous polymer support; and a hydrogen ion conductive polymer impregnated in the porous polymer support. For example, the porous polymer support may be used without limitation as long as it is a porous support applicable to a fuel cell, and the porous polymer support may desirably include one or more types selected from the group consisting of polysulfone, polyarylene ether sulfone, polyarylene ether ketone, polybenzimidazole, polybenzoxazole, polybenzthiazole, polypyrrolone, polyether ether ketone, polyphosphazene, polytetrafluoroethylene (PTFE), polyethylene (PE), polyvinylidene fluoride (PVdF), polyethylene terephthalate (PET), PI, polypropylene (PP), cellulose, and nylon, but is not limited thereto. For example, the hydrogen ion conductive polymer may include, but is not limited to, the ionomer described above.

According to an embodiment, a fuel cell according to the present disclosure may include the MEA according to the present disclosure, and a configuration for driving the same may include a configuration known in the technical field of the present disclosure, and is not specifically mentioned herein.

According to an embodiment, a change rate of an open circuit voltage (OCV) with respect to a unit cell according to Equation 3 below may be 15% or less; 12% or less; 10% or less; or 5% or less. That is, this may refer to a retention rate of 85% or more; 88% or more; 90% or more; or 95% or more. In Equation 3, “OCV after 100 hours” may refer to an OCV value measured after the OCV is applied continuously for 100 hours. For example, the OCV may be applied at 2-hour intervals for 100 hours.

$$Change rate ( \% ) = ( [ Initially applied OCV - OCV after 100 hours ] / [ Initial OCV ] ) * 100 \qquad [ Equation 3 ]$$

(In Equation 3, “OCV after 100 hours” corresponds to a voltage after the OCV is applied continuously at 2-hour intervals for 100 hours.)

Hereinafter, the present disclosure will be described in detail with reference to examples and comparative examples.

However, the following examples are only for illustrating the present disclosure, and the present disclosure is not limited to the following examples.

### Example 1

### Synthesis of Ceria Nanotubes (CeOₓ NT)

An aqueous solution was prepared by mixing Ce(NO₃)₃·6H₂O with NaOH in a molar ratio of 1:120. The aqueous solution was transferred to a Teflon pressure reaction vessel, and then, the pressure reaction vessel was placed in a reaction oven preheated to 100° C. for 24 hours of hydrothermal reaction and cooled to room temperature. After the reaction was completed, the mixed solution was washed with distilled water and centrifuged to remove a supernatant, thereby obtaining ceria nanorods (CeOₓ NR; used in Comparative Example 2). After drying the obtained CeOₓ NR, a CeOₓ NR powder was mixed with Ce(NO₃)₃·6H₂O aqueous solution (0.375 M) at a concentration of 0.3 g L⁻¹, the mixture was transferred to a Teflon pressure reaction vessel, and the pressure reaction vessel was then placed in a reaction oven preheated to 100° C. for 3 hours of hydrothermal reaction and cooled to room temperature. After the reaction was completed, the mixed solution was washed with distilled water, centrifuged, and dried at 60° C., thereby obtaining ceria nanotubes (CeOₓ NT; Example 1).

### Preparation of Catalyst Layer Containing CeOₓ NT

A commercial platinum catalyst (Pt/C; 46.3 wt % Pt; Tanaka, Japan), CeOₓ NT, 5 wt % Nafion resin solution (Sigma-Aldrich, USA), and isopropanol (Honeywell, Germany) were mixed and dispersed using ultrasonic waves for 1 hour to prepare a uniform ink. A weight ratio of platinum to ceria was adjusted to 20:1. Then, the ink was applied onto a glassy carbon disk (0.1936 cm²) of a rotating disk electrode (RDE, Autolab) by a drop casting method to prepare a catalyst layer (hereinafter, a catalyst layer of Example 1) in a form of a film with a catalyst loading amount of 10 μg cm² and a CeOₓ NT loading amount of 0.5 μg cm⁻² based on platinum.

### Preparation of Catalyst Layer-Based MEA and Polymer Electrolyte Membrane Fuel Cell (PEMFC) Unit Cell

An MEA was prepared by a catalyst layer coating method of spray-coating a catalyst ink onto a Nafion 211 electrolyte membrane (DuPont®, USA). For the catalyst ink, a commercial platinum catalyst, CeOₓ NT, 5 wt % ionomer resin solution (solvent: a mixture of n-propanol and distilled water; 3 M, USA), and isopropanol (Honeywell, Germany) were mixed and dispersed using ultrasonic waves for 1 hour to prepare a uniform ink. A weight ratio of platinum to ceria was adjusted to 20:1. The prepared ink was evenly applied using a sprayer over the electrolyte membrane, that is covered with a mask having a hole with a size of 25 cm², to coat a cathode catalyst layer in a form of a thin film with a catalyst loading amount of 0.4 mg cm⁻² and a CeOₓ NT loading amount of 0.02 mg cm² based on platinum. On the opposite side of the electrolyte membrane, a commercial platinum catalyst ink was prepared using the same method as described above, and an anode catalyst layer was coated in a form of a thin film with a catalyst loading amount of 0.2 mg cm² based on platinum. Then, a gas diffusion layer (GDL; 39BB, Sigracet® SGL Carbon Inc., Germany) including a microporous layer (MPL) and a gasket were fixed to upper and lower portions of the electrolyte membrane coated with the catalyst layer to manufacture 7-layer membrane MEA. The manufactured MEA was inserted into a unit cell module formed of a graphite substrate including a serpentine-shaped gas flow channel to manufacture a PEMFC unit cell (hereinafter, a PEMFC unit cell of Example 1).

### Comparative Example 1

A catalyst layer containing commercial CeOₓ NP (nanoparticles) (hereinafter, a catalyst layer of Comparative Example 1) was manufactured, and except for using this, a catalyst layer-based MEA and PEMFC unit cell were manufactured by the same process as in Example 1.

### Comparative Example 2

A catalyst layer containing CeOₓ NR (nanorods), an intermediate product of Example 1, (hereinafter, a catalyst layer of Comparative Example 2) was manufactured, and except for using this, a catalyst layer-based MEA and PEMFC unit cell were manufactured by the same process as in Example 1.

### Experimental Example

### (1) Evaluation of RDE-Based PEMFC Cathode Oxygen Reduction Reaction (ORR) Activity

The ORR activity of the cathode catalyst layer manufactured in Example 1 was measured by linear scanning voltammetry (LSV) using a potentiostat device (PGSTAT302N, Metrohm Autolab, Netherlands). An RDE coated with the manufactured cathode catalyst layer as a working electrode, a glassy carbon rod as a counter electrode, and a reversible hydrogen electrode (RHE) as a reference electrode were connected to form a three-electrode system within an oxygen-saturated 0.1 M HClO₄ solution. In the three-electrode system, the activity was measured by rotating the RDE at 1,600 rpm and changing a potential from 0.01 to 1.10 V to obtain a current.

### (2) Evaluation of RDE-Based PEMFC Cathode ORR Durability

An ORR accelerated degradation test (ADT) was performed by subjecting the three-electrode system to 5,000 potential cycles at potentials between 0.6 and 1.0 V in an argon-saturated 0.1 M HClO₄ solution. The ORR activity after the ADT was measured using the activity evaluation method described above, and then the ORR activities before and after the ADT were compared and evaluated.

### (3) Evaluation of RDE-Based PEMFC Cathode Oxygen Affinity

To evaluate the hydrogen peroxide reactivity of the catalyst layer manufactured in Example 1, the electrochemical behavior of the three-electrode system was investigated at potentials between 0.05 and 1.50 V in an argon-saturated 0.1 M HClO₄+0.01 MH₂O₂ solution. The hydrogen peroxide reactivity was measured through the LSV measurement at various rotation speeds (900, 1,225, 1,600, 2,025, and 2,500 rpm). A redox mixed potential was determined at an intersection of each LSV curve, and the oxygen affinity of the catalyst layer was evaluated through the potential.

### (3) Evaluation of RDE-Based PEMFC Cathode Hydrogen Peroxide Reduction Rate

The LSV curve obtained from the experimental example was used to obtain a Koutecký-Levich diagram using Koutecký-Levich equation, and a reaction rate constant (k_{PRR}) for hydrogen peroxide reduction was calculated from a Y-intercept of the diagram.
Y-intercept: [n·F·k_{PRR}·CH2O2,b]−1 (reciprocal of a kinetic current density of a reaction)
n: number of electrons (n=2); F: Faraday constant (96485 C mol⁻¹); CH2O2,b: concentration of H₂O₂ in an electrolyte solution (0.01 M)

### (4) Analysis of Current-Voltage (I-V) Performance of PEMFC Unit Cell

To evaluate I-V performance of the PEMFC unit cell manufactured in Example 1, the unit cell was connected to a fuel cell station (C&L Energy, Korea), a temperature of the PEMFC was set to 80° C., and flow rates of a hydrogen gas to the anode and air to the cathode were set to 0.525 L min-1 and 1.252 L min-1, respectively. A voltage of 0.4 V was applied for 3 hours or longer to activate the unit cell, and then, an I-V curve was obtained using a current injection method by setting a relative humidity and pressure to RH 100% and 1 bar, respectively.

### (5) Evaluation of Voltage Stability of MEA in Low-Humidity Environment

In order to evaluate the stability of the PEMFC unit cell manufactured in Example 1, a temperature of the unit cell was set to 90° C., flow rates of a hydrogen gas to the anode and air to the cathode were set to 0.35 L/min and 0.835 L/min, respectively, a relative humidity and pressure were set to RH 30% and 1.5 barA, respectively, and a change rate of an OCV was measured for 100 hours.

### Result

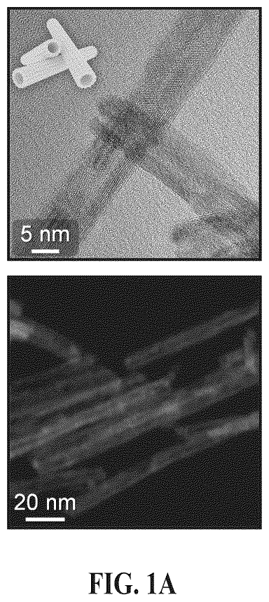

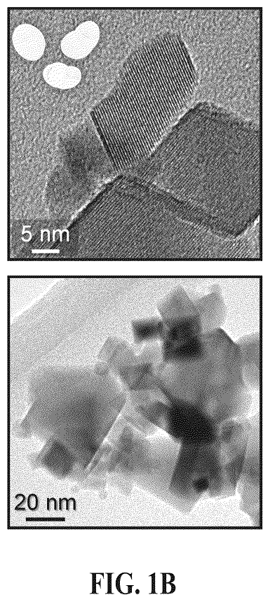

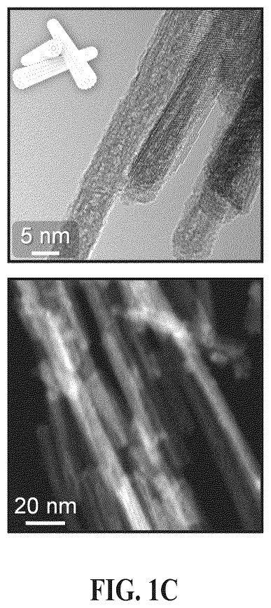

FIG. 1A illustrates transmission electron microscope (TEM) images of CeOₓ NT manufactured in Example 1 according to an embodiment. FIG. 1B illustrates TEM images of commercial ceria nanoparticles used in Comparative Example 1 according to an embodiment. FIG. 1C illustrates TEM images of ceria nanorods, an intermediate product of Example 1, according to an embodiment.

Through TEM analysis in FIG. 1A, it may be confirmed that CeOₓ NT having a hollow structure with a length of several hundred nm or more and a thickness of 9 nm is synthesized. Through the TEM analysis in FIG. 1B, it may be confirmed that commercial CeOₓ NP has an irregular shape with an average size of 20 nm.

Through TEM analysis in FIG. 1C, it may be confirmed that CeOₓ NR having a nanowire structure with a length of several hundred nm or more and a thickness of 9 nm is synthesized.

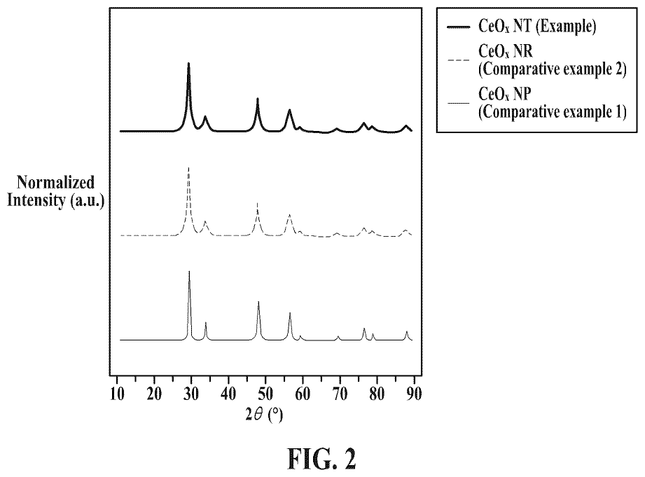

FIG. 2 illustrates X-ray diffraction (XRD) pattern analyses of Example 1, Comparative Example 1, and Comparative Example 2 according to an embodiment. In FIG. 2, Example 1, Comparative Example 1, and Comparative Example 2 all show a CeO₂ cubic phase. In Example 1, Comparative Example 1, and Comparative Example 2, crystal grain sizes calculated by the Scherrer equation were 8.1 nm, 28.2 nm, and 9.3 nm, respectively. Example 1 and Comparative Example 2 show a peak of the XRD pattern shifted to the left, compared to Comparative Example 1, and this may imply extension of crystal lattice due to an increase in oxygen vacancy resulting from a decrease in the crystal grain size.

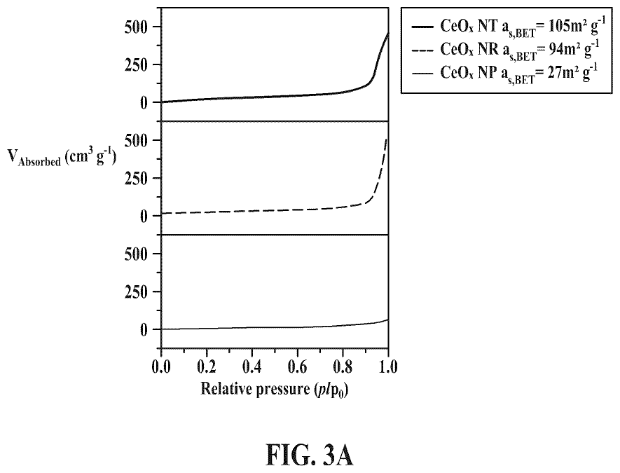

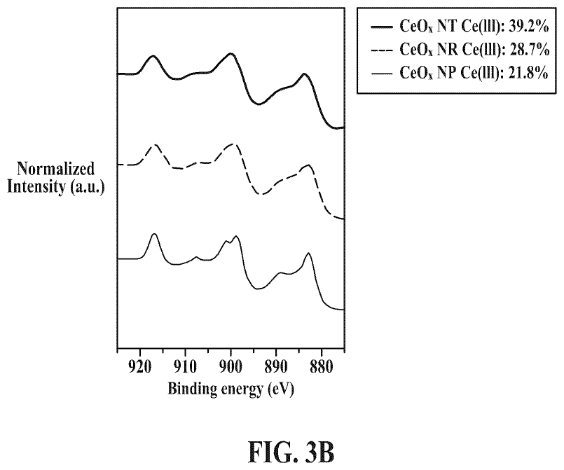

FIGS. 3A and 3B show results of analysis of physicochemical structures of Example 1, Comparative Example 1, and Comparative Example 2 according to an embodiment, wherein FIG. 3A shows a result of N₂ physical absorption and desorption analysis and FIG. 3B shows an analysis of an X-ray photoelectron spectrum. In the N₂ physical absorption and desorption analysis result of FIG. 3A, it may be confirmed that Example 1 has a larger specific surface area (105 m² g⁻¹) than Comparative Example 1 (27 m² g⁻¹) and Comparative Example 2 (94 m² g⁻¹) due to internal pores and a small crystal grain size.

In the X-ray photoelectron spectrum analysis of FIG. 3B, Example 1 shows a highest Ce(III) ratio due to a high oxygen vacancy concentration.

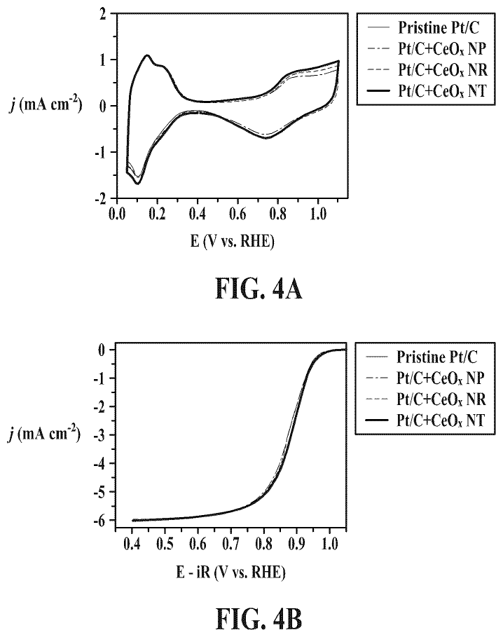

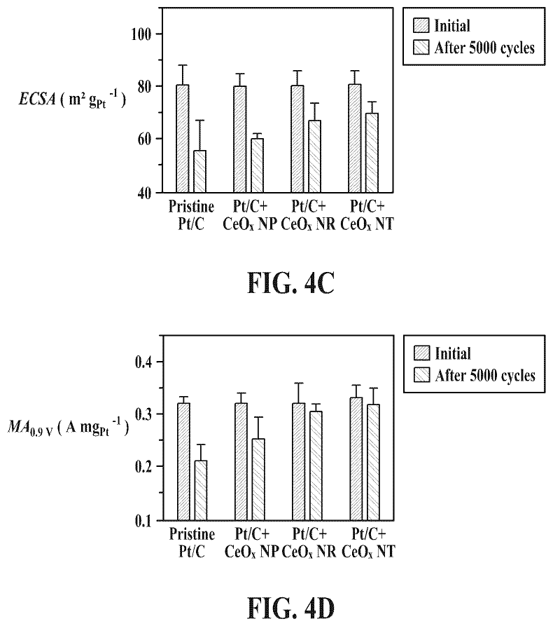

FIGS. 4A, 4B, 4C, and 4D show results of analysis of ORR characteristic of the catalyst layers manufactured in Example 1, Comparative Example 1, and Comparative Example 2 according to an embodiment, wherein FIG. 4A shows a cyclic voltammetry (CV) graph, FIG. 4B shows an ORR graph, FIG. 4C shows an analysis of changes in ECSA before and after durability evaluation, and FIG. 4D shows an analysis of changes in MA before and after durability evaluation. In the CV graph of FIG. 4A, it may be confirmed that Example 1 shows substantially the same redox behavior as Comparative Examples 1 and 2 and the commercial platinum catalyst, and the incorporation of CeOₓ does not affect the properties of Pt.

In the ORR graph of FIG. 4B, it may be confirmed that Example 1 shows ORR activity similar to that of Comparative Examples 1 and 2 and the commercial platinum catalyst, and the effect of CeOₓ incorporation on the ORR activity is relatively small.

From the analysis of the changes in the ECSA before and after the durability evaluation of FIG. 4C, it may be confirmed that the CeOₓ incorporation is effective in improving the durability of Pt/C. Also, the durability improvement effect is shown in the order of Example 1>Comparative Example 2>Comparative Example 1.

The analysis of the changes in the MA before and after the durability evaluation of FIG. 4D also shows improvement of durability due to the incorporation of CeOₓ, and shows the same durability improvement trend as the ECSA change (Example 1>Comparative Example 2>Comparative Example 1).

That is, although the catalyst layer without antioxidant, Example 1, Comparative Example 1, and Comparative Example 2 have little difference in initial performance, a clear difference may be confirmed in durability (ORR durability) after durability evaluation (i.e., ADT).

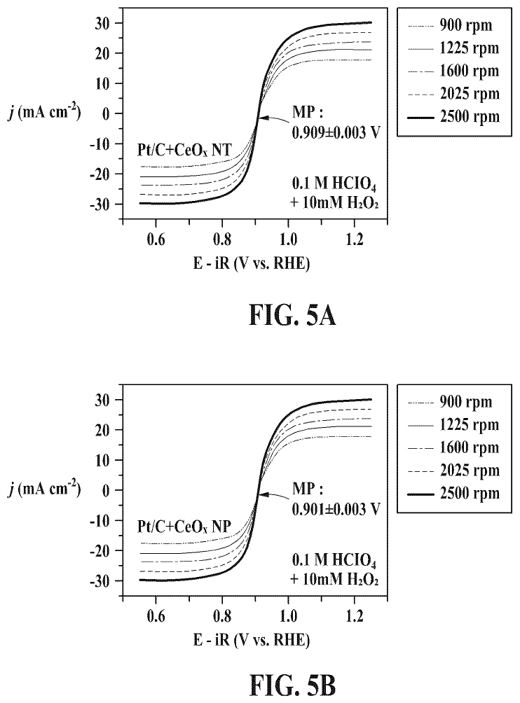

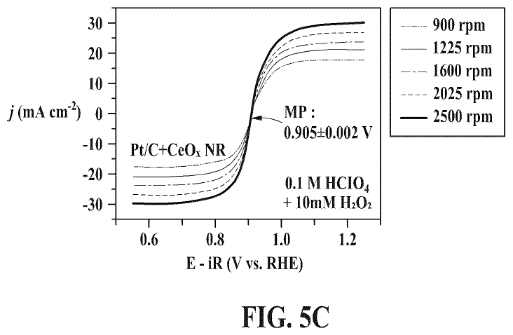

FIGS. 5A, 5B, and 5C show analyses of oxygen affinity of the catalyst layers manufactured in Example 1 (FIG. 5A), Comparative Example 1 (FIG. 5B), and Comparative Example 2 (FIG. 5C) according to an embodiment.

In the graphs of FIGS. 5A, 5B, and 5C, a negative (−) current density indicates a reaction rate of the reduction reaction, and a positive (+) current density indicates a reaction rate of the oxidation reaction. That is, a point where the current density is 0 is an equilibrium point where the rates of reduction and oxidation reactions are equal, and a mixed potential is formed at the point. Also, as the mixed potential is a positive value, the reduction reaction is more dominant, which indicates lower average oxygen affinity on an electrode surface.

FIG. 5A, FIG. 5B, and FIG. 5C show that the mixed potential of Example 1 is 0.909 V, which is higher than Comparative Example 1 (0.901 V) and Comparative Example 2 (0.905 V), and this implies that the oxygen affinity is the lowest. When the oxygen affinity is low, an ORR reaction rate may be increased, which may improve activity, and the amount of oxygen species adsorbed, which is the main cause of Pt dissolution, may be reduced, which may also improve stability.

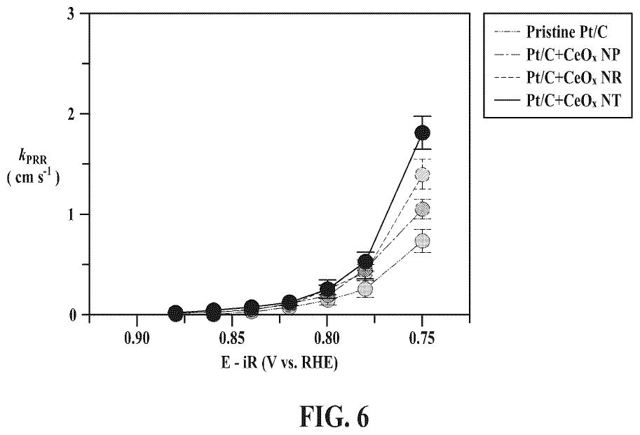

FIG. 6 shows results of evaluating hydrogen peroxide reduction rates of catalyst layers of Example 1, Comparative Example 1, and Comparative Example 2 according to an embodiment. That is, a reaction in which hydrogen peroxide is reduced and transformed into water was electrochemically induced, and a current density of the reaction was measured to calculate a reaction rate constant.

Referring to FIG. 6, it may be confirmed that the reaction rate constant of the hydrogen peroxide reduction reaction is improved when CeOₓ is mixed into a commercial platinum catalyst. In particular, the catalyst layer of Example 1 shows a greater reaction rate constant than the catalyst layers of Comparative Examples 1 and 2. This shows that the catalyst layer of Example 1 has high efficiency in hydrogen peroxide and radical scavenging.

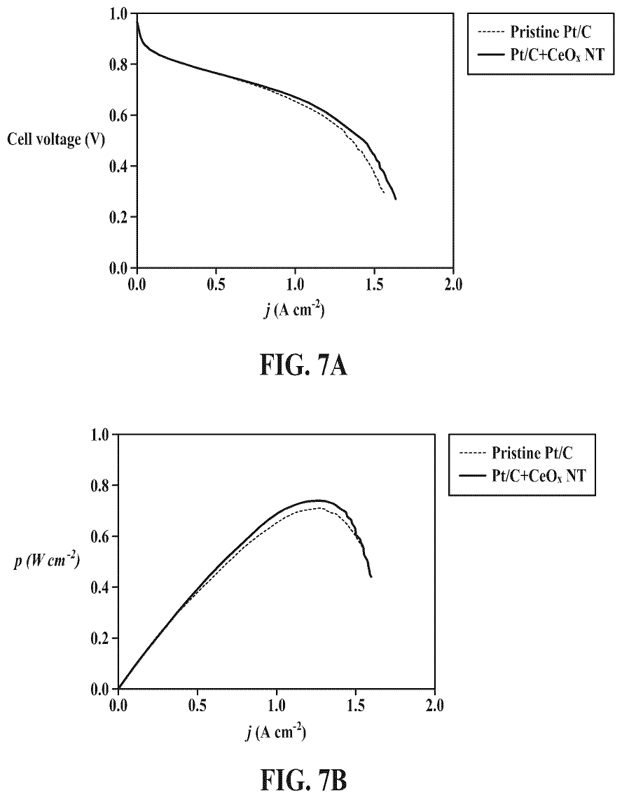

FIGS. 7A and 7B show comparisons of current-voltage performance (FIG. 7A) and current-power performance (FIG. 7B) of a PEMFC unit cell manufactured using the catalyst layer of Example 1 (hereinafter, referred to as a PEMFC of Example 1) according to an embodiment.

In FIG. 7A, it may be confirmed that the PEMFC of Example 1 secures a higher voltage at the same current density compared to a commercial platinum catalyst-based unit cell (Pristine PV/C). In FIG. 7B, the PEMFC of Example 1 shows a higher power density than a commercial platinum catalyst-based unit cell (Pristine PV/C) to confirm an effect of improving the performance by introducing CeOₓ NT. That is, the MEA including the ceria nanotube antioxidant according to the present disclosure may improve the initial performance by introducing the ceria nanotube antioxidant by securing a higher voltage at the same current density and also having a higher maximum power density compared to an MEA not including the antioxidant.

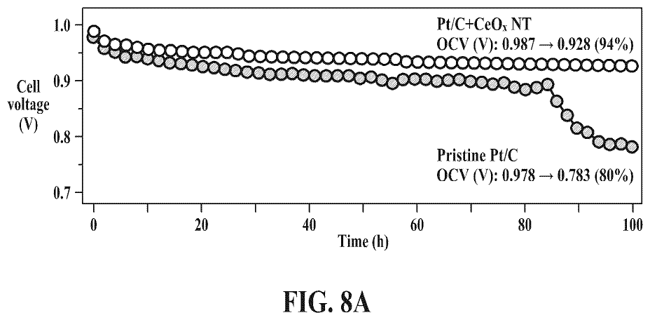

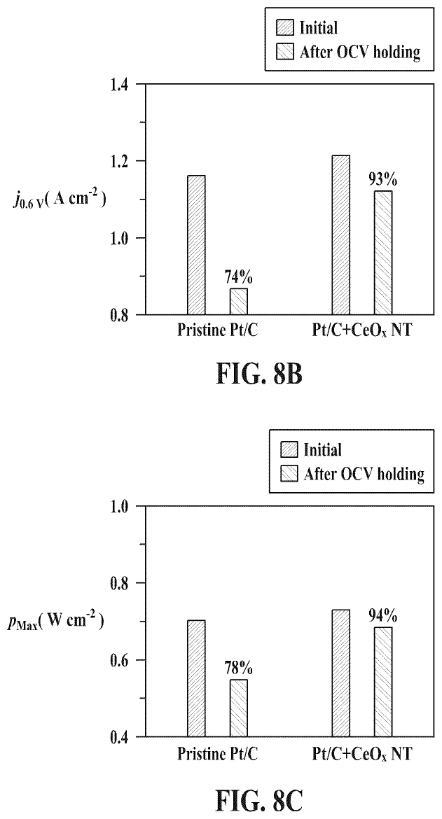

FIGS. 8A, 8B, and 8C show comparisons of durability of the PEMFC unit cell manufactured using the catalyst layer of Example 1 according to an embodiment. That is, in order to evaluate the durability of the PEMFC manufactured using the catalyst layer of Example 1, the ADT was performed through continuous application of the OCV for 100 hours, and a comparison was made with the commercial platinum catalyst-based unit cell (Pristine PV/C).

As shown in FIG. 8A, FIG. 8B, and FIG. 8C, an OCV retention rate after 100 hours was 94%, which was confirmed to retain a much higher OCV than that of a commercial platinum catalyst-based unit cell (80%). In addition, Example 1 exhibits excellent durability by retaining a current density and a maximum power density at a higher rate than a commercial platinum catalyst-based unit cell after the ADT.

According to an embodiment, the present disclosure may provide a ceria nanotube antioxidant having a controlled size and shape with plentiful defective parts and being utilized as a highly efficient antioxidant in an antioxidant-based electrode layer, and an electrode (layer) including the same. The antioxidant-based electrode (layer) may secure long-term durability for a redox reaction and provide an MEA and PEMFC with improved durability and performance.

According to an embodiment, unlike commercial ceria nanoparticles and catalysts of the related art having irregular shapes and particle sizes, the nanotube structure of the present disclosure has a large specific surface area and contains many defective sites on a surface thereof, to have a high proportion of Ce(III) chemical species that are highly reactive to radical scavenging, thereby providing a highly efficient anti-oxidation function, and when forming an electrode layer, the nanotubes may induce more contact with the catalyst layer than the nanoparticles, thereby providing strong resistance to ceria dissolution and loss. Therefore, the ceria nanotube antioxidant may suppress catalyst/ionomer damage caused by radical chemical species in a cathode layer and secure excellent durability without initial performance degradation at the unit cell level.

According to an embodiment, the present disclosure may prevent the formation of radical chemical species generated at an electrode by incorporating the ceria nanotube antioxidant into the cathode layer, thereby securing excellent durability without initial performance degradation at the unit cell level.

According to an embodiment, the present disclosure may manufacture an MEA by mixing the ceria nanotube antioxidant with a catalyst slurry and introducing the mixture into upper/lower electrode layers of an electrolyte membrane through a coating process. It is similar to the general MEA manufacturing method, and thus, large-area production may be possible. Also, a simple coating process is utilized, and therefore, damage to the electrolyte membrane that occurs during the MEA manufacturing may be reduced. Since the ceria nanotube antioxidant is included in the electrode layer, there is no interference with the ion conductivity of the electrolyte membrane, and thus, excellent durability may be secured without initial performance degradation.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An electrode for fuel cell comprising:
a catalyst layer comprising:
a ceria nanotube antioxidant; and
a catalyst.

2. The electrode of claim 1, wherein the ceria nanotube antioxidant has a Brunauer-Emmett-Teller (BET) specific surface area of 100 m²g⁻¹ or more, a diameter of 1 nanometer (nm) to 20 nm, and a length of 30 nm or more.

3. The electrode of claim 1, wherein a proportion of Ce³⁺ in the ceria nanotube antioxidants is 30% or more.

4. The electrode of claim 1, wherein a mass ratio of the ceria nanotube antioxidant to the catalyst is 1:1 to 30.

5. The electrode of claim 1, wherein the catalyst is a platinum catalyst.

6. The electrode of claim 1, wherein a loading amount of the ceria nanotube antioxidant in the catalyst layer is 0.1 μg cm⁻² to 1 μg cm².

7. The electrode of claim 1, wherein
a change rate of an electrochemical active surface area (ECSA) of the catalyst layer according to Equation 1 is 30%, and
a change rate of mass activity (MA) of the catalyst layer of the catalyst according to Equation 2 is 20% or less.
$$Change rate ( \% ) = ( [ Initial ECSA value - ECSA value after 5 , 000 cycles ] / [ Initial ECSA value ] ) * 100 \qquad [ Equation 1 ]$$
$$Change rate ( \% ) = ( [ Initial MA value - MA value after 5 , 000 cycles ] / [ Initial MA value ] ) * 100 \qquad [ Equation 2 ]$$

8. The electrode of claim 1, comprising:
an ionomer included in an amount of 1 wt % to 30 wt % with respect to a total weight of the ceria nanotube antioxidant in the catalyst layer.

9. A membrane-electrode assembly (MEA) comprising:
a first electrode layer comprising the electrode of claim 1;
a second electrode layer; and
an electrolyte membrane between the first electrode layer and the second electrode layer.

10. A fuel cell comprising:
the MEA of claim 9.

11. The fuel cell of claim 10, wherein a change rate of an open circuit voltage (OCV) with respect to a unit cell according to Equation 3 is 15% or less.
$$Change rate ( \% ) = ( [ Initially applied OCV - OCV after 100 hours ] / [ Initial OCV ] ) * 100 \qquad [ Equation 3 ]$$
(in Equation 3, “OCV after 100 hours” corresponds to a voltage after the OCV is applied continuously at 2-hour intervals for 100 hours)
